(19) United States
(12) Patent Application Publication
(10) Pub. No.: US 2006/0036551 A1
(43) Pub. Date: Feb. 16, 2006

(54) Protecting elementary stream content

(75) Inventors: Eduardo Oliveira, Redmond, WA (US); Anders E. Klemets, Redmond, WA (US); Gurpratap Virdi, Bellevue, WA (US); Thaddeus C. Pritchett, Edmonds, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/202,836

(22) Filed: Aug. 12, 2005

Related U.S. Application Data
(63) Continuation-in-part of application No. 10/811,030, filed on Mar. 26, 2004.

(51) Int. Cl. H04L 9/00

(52) U.S. Cl. 705/51

(57) ABSTRACT

Protecting elementary stream media content is described. In one aspect, data segments within elementary stream media content are identified. Each data segment includes a single video or audio frame. Encryption boundaries for protecting the payload packets are selected to correspond to data segment boundaries. The elementary stream media content is then protected using the selected encryption boundaries.

### RELATED APPLICAITONS

This patent application is a continuation-in-part of U.S. patent application Ser. No. 10/811,030, titled “Common Scrambling”, filed on Mar. 26, 2004, commonly owned hereby, and incorporated by reference.

### BACKGROUND

A media center typically removes encryption from a protected transport stream carrying media content to demultiplex the transport stream (TS) into elementary streams (ESs) for subsequent re-encryption, and delivery to a media subscriber (consumers, clients, etc.) over a network connection. Such decryption and re-encryption operations by the media center may compromise security because decrypted content is vulnerable to piracy and other security breaches. “Media content,” is synonymous with “content,” and “media signals,” which may include one or more of video, audio content, pictures, animations, text, etc.

Media subscribers, such as set-top boxes (STBs), digital media receivers (DMRs), and personal computers (PCs), typically receive protected media content from a media center, or content source. Protected media content includes encrypted audio/video data transmitted over a network connection, or downloaded from a storage medium. To process the encrypted media content (e.g., for indexing), a media subscriber typically needs to remove the media content protection (i.e., decrypt the media content). Such decryption operations typically consume substantial device resources and reduce device performance, and as a result, can compromise device responsiveness and functionality.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In view of the above, protecting elementary stream (ES) media content is described. In one aspect, data segments within ES media content are identified. Each data segment includes a single video or audio frame. Encryption boundaries for protecting the payload packets are selected to correspond to data segment boundaries. The ES media content is then protected using the selected encryption boundaries.

### BRIEF DESCRIPTION OF THE DRAWINGS

The detailed description is described with reference to the accompanying figures.

FIG. 1 shows an exemplary computing system to protect ES content, according to one embodiment.

FIG. 2 shows an exemplary networked environment in which example embodiments to protect ES content carried by a transport stream may be implemented, according to one embodiment.

FIG. 3 shows exemplary aspects of operations utilizing Advanced Encryption Standard in Counter Mode to encrypt ES media content.

FIG. 4 shows an exemplary encryption method (TAG) packet for insertion along with protected ES content into the transport stream, according to one embodiment.

FIG. 5 shows an exemplary procedure for a transmitter to protect ESs within a transport stream, according to one embodiment.

FIG. 6 shows an exemplary commonly scrambled transport stream, according to one embodiment.

FIG. 7 illustrates an exemplary high-level structure of Media Access Unit (MAU) Payload Format (MPF) Header, according to one embodiment.

FIG. 8 shows exemplary detail of the MPF header of FIG. 7, according to one embodiment.

FIG. 9 illustrates an exemplary sequence of three Real-Time Transport Packet (RTP) packets that use the MPF, according to one embodiment.

FIG. 10 shows an example where a single Media Access Unit (MAU) has been split into three fragments in a same RTP packet, according to one embodiment.

FIG. 11 illustrates a standard 12-byte RTP header.

FIG. 12 shows an exemplary layout of Bit Field 3 of the MPF.

FIG. 13 shows an exemplary layout of the extension field of a MPF Header, according to one embodiment.

FIG. 14 shows an exemplary procedure to protect ES content, according to one embodiment.

### DETAILED DESCRIPTION

Overview

Systems and methods to protect ES content by selecting encryption boundaries based on media content specific properties are described. More particularly, the systems and methods encrypt (e.g., using MPEG-2, etc.) portions of a Media Access Unit (MAU) of an ES. Each MAU is a single video or audio frame (elementary stream frame) and associated headers. A MAU includes one or more data segments. Each data segment is a contiguous section of a MAU to which a same set of content encryption parameters apply. A data segment is either completely encrypted or completely in the clear (i.e., unencrypted). The ESs may not have originated from a TS. However, these ES protection operations are compatible with common scrambling operations applied to a TS stream.

If a TS contains protected ES content, the TS is demultiplexed into ESs while preserving existing encryption (i.e., the TS is not decrypted). The ESs are mapped to a MAU payload format (MPF) to encapsulate MAUs of an ES into a transport protocol (e.g., Real-Time Transport Protocol (RTP)) for subsequent communication to media consumers, such as PCs and set-top boxes. Mapping each MAU to the MPF provides a media consumer with enough information to process (e.g., demultiplex, index, store, etc.) each ES independently of any other ES, and process each MAU independently of any other MAU. These techniques are in contrast to conventional systems, which do not protect ES content by applying encryption to MAU portions composed of one or more data segments.

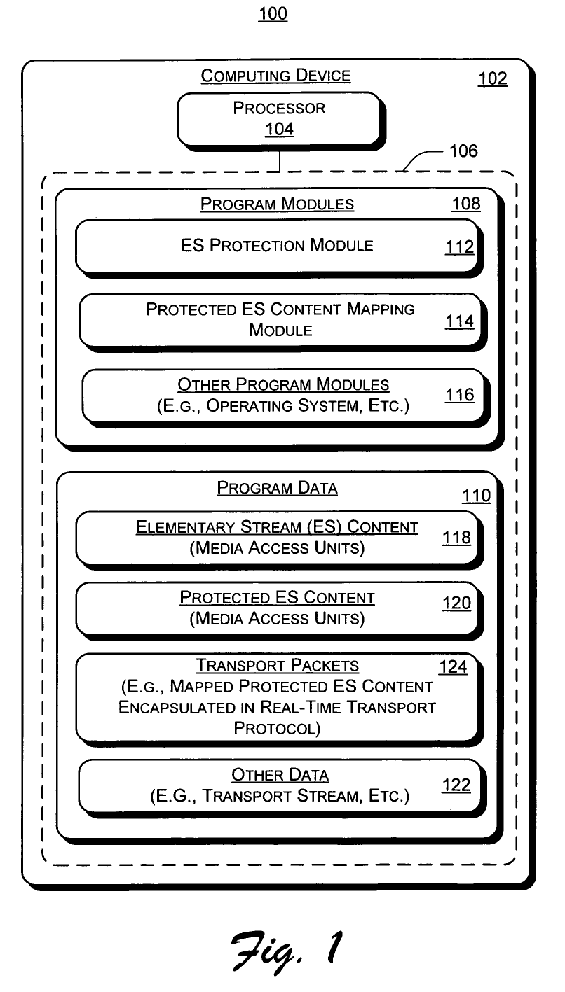

These and other aspects of the systems and methods to protect ES content are now described in greater detail with reference to FIGS. 1 through 14.

Exemplary Apparatus

For purposes of discussion, and although not required, protecting ES content is described in the general context of computer-executable instructions being executed by a computing device such as a personal computer. Program modules generally include routines, programs, objects, components, data structures, etc., that perform particular tasks or implement particular abstract data types. While the systems and methods are described in the foregoing context, acts and operations described hereinafter may also be implemented in hardware.

FIG. 1 shows an exemplary system 100 to protect ES content. System 100 includes a general-purpose computing device 102. Computing device 102 represents any type of computing device such as a personal computer, a laptop, a server, handheld or mobile computing device, etc. Computing device 102 includes a processor 104 coupled to computer-readable media 106. Computer-readable media 106 can be any available media accessible by computing device 102, including both volatile and nonvolatile media (e.g., read only memory (ROM) and random access memory (RAM)), removable and non-removable media. A RAM portion of computer-readable media 106 includes program modules and program data that are immediately accessible to and/or presently being operated on by processor 104.

By way of example and not limitation, computer-readable media 106 includes program modules 108 and program data 110. Program modules 108 include, for example, ES protection module 112, protected ES content mapping module 114, and other program modules 116 (e.g., an operating system). ES protection module 112 protects ES content by selecting encryption boundaries based on media content specific properties. More particularly, ES protection module 112 encrypts (e.g., using MPEG-2, etc.) ES content 118 to generate protected ES content 120. To this end, ES protection module 112 applies encryption to portions (i.e., data segments) of Media Access Units (MAUs) that comprise the ES. In one implementation, the encryption operations are Advanced Encryption Standard (AES) in Counter Mode. Each MAU is a single video or audio frame (elementary stream frame), which is subsequently associated with headers (e.g., start codes and padding bits). Each MAU includes one or more data segments. Each data segment is a contiguous section of a MAU to which ES protection module 112 applies a same set of content encryption parameters. ES protection module 112 either completely encrypts the data segment, or leaves the data segment completely in the clear. The ESs may not have originated from a TS. However, these ES protection operations are compatible with common scrambling operations applied to a TS stream (e.g., see “other data” 122).

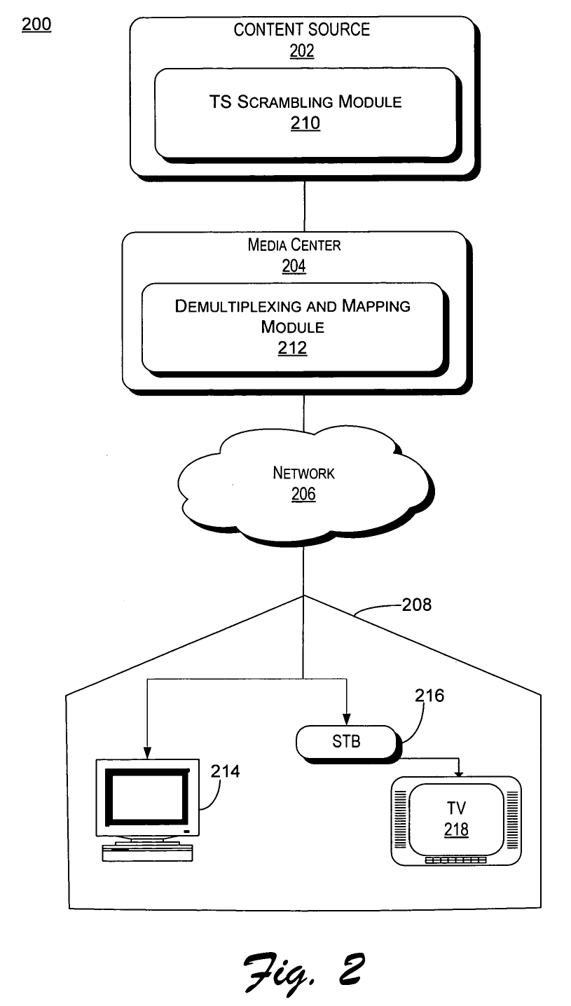

Protected ES content mapping module 114 (“mapping module 114”) maps protected ES content 120 to a MAU payload format (MPF) for encapsulation into transport packets 124. The MPF allows portions of a MAU to pass unencrypted (left in the clear). The MPF also provides enough information to allow a media consumer, such as a personal computer or a set-top box (e.g., see FIG. 2), to process each protected ES 120 independently of any other ES, and process each MAU in the protected ES independently of any other MAU. The MPF is described in greater detail below in reference to the section titled “Mapping Protected ES for Transport Protocol Encapsulation”. In one implementation, the transport packets correspond to packets based on the Real-Time Transfer Protocol (RTP).

In one embodiment, ES content (e.g., ES content 118) does not originate in a media content transport stream. In another embodiment, for example, as described below in reference to FIG. 2, ES content does originate in a transport stream. Additionally, although exemplary system 100 shows protected ES content mapping module 114 being implemented in a same computing device as ES protection module 112, mapping module 114 may be implemented in a different computing device from the computing device that implements protection module 112. Such an alternate implementation is described below in reference to FIG. 2, wherein operations of the protection module 112 are implemented by a content source, and operations of the mapping module 114 are implemented by a media center.

Exemplary System

FIG. 2 shows an exemplary system 200 to protect ES content, wherein the ES content originates in a transport stream, according to one embodiment. The transport stream encapsulates media content. System 200 includes, for example, content source 202 and media center 204 coupled across network 206 to one or more media subscribers 208. Content source 100 may be associated with a video game server, a website, a video server, music server, software archive, database, television network, etc. TS scrambling module 210 of content source 202 encrypts the transport stream. In one implementation, transport stream encryption 210 common scrambles the transport stream. Common scrambling allows the encrypted transport stream to be processed (e.g., demultiplexed, indexed, etc.) without requiring encrypted portions of the stream to be decrypted. TS scrambling module 210 protects ES content that originates in the transport stream as described above with respect to ES protection module 112 of FIG. 1, as the module's associated operations are compatible with common scrambling operations applied to a TS stream.

Media Center 204 is a centrally located computing device that may be coupled to content source 202 directly or via network 206, for example, using Transmission Control Protocol/Internet Protocol (TCP/IP) or other standard communication protocols. Examples of network 206 include IP networks, cable television (CATV) networks and direct broadcast satellite (DBS) networks. Media center 204 includes demultiplexing and mapping module 212. Although shown as a single computer-program module, module 212 may be implemented with an arbitrary number of computer-program modules. Demultiplexing operations of program module 212 demultiplex the TS into respective ESs, without decrypting encrypted portions of the TS.

Mapping operations of program module 212 map the demultiplexed protected ES content to the MPF, as per the described operations of protected ES content mapping module 114 of FIG. 1, for subsequent encapsulation into transport packets for communication to a media consumer. As described above, the MPF allows data segment of a MAU to be left in the clear when encapsulated in a transport packet(s). The MPF also provides enough information to allow a media subscriber 208 to process received and a protected ES independently of any other ES, and process each associated MAU in a protected ES independently of any other MAU. The MPF is described in greater detail below in reference to the section titled “Mapping Protected ES for Transport Protocol Encapsulation”. In one implementation, the transport packets correspond to packets based on the Real-Time Transfer Protocol (RTP).

Media Center 204 communicates the encapsulated protected ES content over a network 206 to one or more subscribers 208, wherein PC 214 and/or STB 216 receive the media content. Media content processed and rendered on PC 214 may be displayed on a monitor associated with PC 214; and media signals processed and rendered on STB 216 may be displayed on television (TV) 218 or similar display device. In one implementation, TV 218 has the capabilities of STB 216 integrated therein.

### Transport Stream Common Scrambling Analysis

In one implementation, ES content is carried by a transport stream. In this scenario, TS scrambling module 210 of content source 202, analyzes the transport stream for common scrambling. In particular, the transport stream is analyzed in view of data requirements for at least one process to which the transport stream may be subjected after being encrypted. If the determination is made based upon a statistical model corresponding to one or more of the processes, threshold data requirements may be determined for the particular process that has the most extensive (i.e., threshold) data requirements. This analysis is performed to determine which portions of the transport stream are to pass unencrypted.

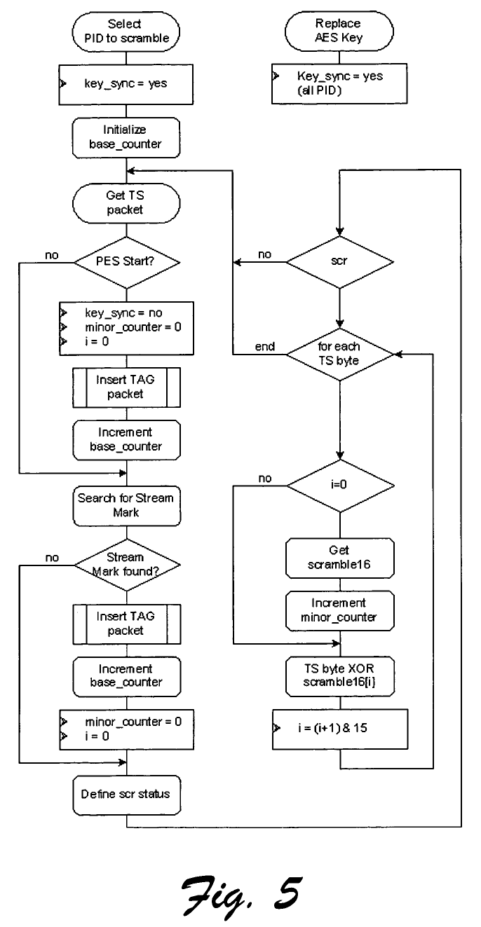

The common scrambling analysis may incorporate acknowledgements that any packet within the transport stream that contains any header information is to pass unencrypted. A description of such packets and header information is provided below with reference to FIG. 6. Packets containing any portion of PES header information or any portion of the “extra header data” are to pass unencrypted. Additionally, packets containing a complete, or partial Stream Mark, pass unencrypted.

TABLE 1
EXEMPLARY MARKS TO INDICATE DATA IS TO BE LEFT
UNENCRYPTED

| | | | Maximum data |
|---|---|---|---|
| Stream mark | Start code | Byte sequence | payload length |
| Sequence header | B3 | 00 00 01 B3 | 12 bytes |
| GOP header | B8 | 00 00 01 B8 | 8 bytes |
| Picture header | 00 | 00 00 01 00 | 6 bytes |
| Private data | B2 | 00 00 01 B2 | 107 bytes |

Referring to TABLE 1, the amount of data to be left in the clear in this implementation corresponds, to the length of the Stream Mark plus the Maximum Data Payload Length. Notice, that the clear section may start prior to the Stream Mark and end after the combined length of the Stream Mark and a maximum data payload length, as long as the combined length does not exceed, for example, the length of two consecutive TS packet payloads. For example, a Transmitter (e.g., content source 202 of FIG. 2, etc.) may leave between 16 and 368 bytes in the clear for a Stream Mark which denotes a Sequence Header (4 bytes for the Stream Mark plus 12 bytes for the Maximum Data Payload Length).

It is also possible to have some amount of data from a previous MAU left in the clear, in case the Stream Mark appears near the beginning of the current MAU. In one implementation, this is allowed when the length of the clear section does not exceed 368 bytes.

Since any portion of a transport stream may pass unencrypted, further alternate embodiments may contemplate frame headers and PES headers having common scrambling applied thereto if the data contained therein is not used for processing the transport stream without descrambling.

### Encryption

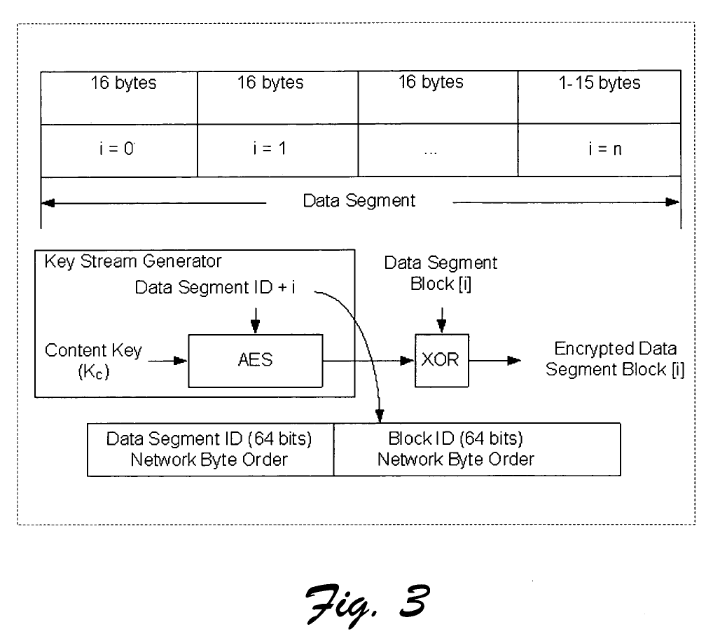

FIG. 3 is a block diagram showing exemplary aspects of operations utilizing Advanced Encryption Standard (AES) in Counter Mode to encrypt ES media content. The various data and operations described below in reference to FIG. 3, represent exemplary operations of ES protection module 112 of FIG. 1 and exemplary operations of TS scrambling module 210 of FIG. 2. Although a data segment may have different definitions based on the type of content being protected, when encrypting ESs, a MAU including any number of data segments, represents single frame of video or audio.

Referring to FIG. 3, AES in Counter Mode creates a stream of bytes based on respective data segments of the transport stream. The stream of bytes is XOR'd with any clear text bytes of the content to create the encrypted content. The Key Stream Generator utilizes an AES round to generate 16-byte blocks of key stream at a time. The inputs to the AES round are the content encryption key (KC) and the 128 bit concatenation of a data segment ID and the block ID within the new segment. The output of the key stream generator is XOR'd, byte by byte, with the data from the corresponding block (i) of the data segment. In case the data segment is not evenly divisible by 16 bytes, only the remaining bytes of the data segment from the last block are XOR'd with the key stream and retained for the encrypted data set in. A MAU, and associated headers, represents are more data segments.

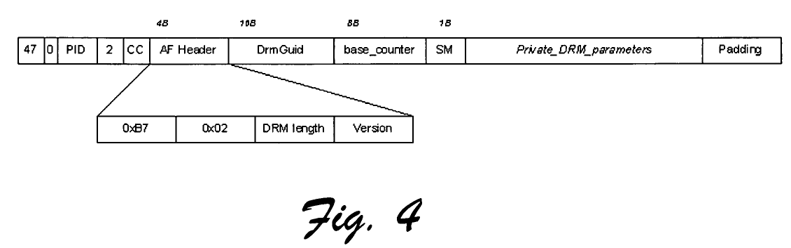

FIG. 4 shows an exemplary encryption method (“TAG”) packet for insertion into a transport stream that carries protected ESs. Referring to FIG. 4:
The adaptation_field_control bits are set to 10b (adaptation field only, no payload), so there is no requirement to increment the continuity counter.
The AF Header includes four bytes to be compliant with MPEG specification:
   1st Byte=Adaptation Field length
   2nd Byte=Adaptation Field presence flag (Private data=0×02)
   3rd Byte=Private data length (DRM Length)
   4th Byte=Version number (currently 0×00)
DrmGuid includes the GUID set to {B0AA4966-3B39-400A-AC35-44F41B46C96B}.
The base_counter resynchronizes the AES counter for the encrypted packet that follows.
SM byte (Stream Mark) indicates that the following packet includes the beginning of a Stream Mark, from which the first few bytes may be missing.
   SM=0—Next packet carries the beginning of a PES header or an entire PES header.
   SM=1—Next packet includes the beginning of a Stream Mark.
   SM=2—Next packet includes the beginning of a Stream Mark, from which the first byte (00) is missing.
   SM=3—Next packet includes the beginning of a Stream Mark, from which the first two bytes (00 00) are missing.
   SM=4—Next packet includes the beginning of a Stream Mark, from which the first three bytes (00 00 01) are missing.
   SM=other—Reserved.
The Private_DRM_parameters contain a Data Segment Descriptor, which includes a Key ID extension set with the corresponding Key ID value. The AES128 Initialization Vector extension is not present, since the data segment ID is indicated in the base_counter section of the TAG packet.
The packet is padded with 0×FF.

Accordingly, a TAG packet is a single TS packet with a Key Identifier (KID) that is inserted in front of each protected PES unit. In this implementation, the TAG packet is used to retrieve a matching Digital Rights Management (DRM) license when the content is delivered to a media consumer. The content protection layer includes an AES 128 bit key in Counter Mode, where the following requirements apply: The 128 bit counter is divided in two 64 bit fields: The base_counter (MSB) and the minor_counter (LSB). The base_counter and minor_counter are equivalent to the data segment ID and block ID described above. A TAG packet may provide identification for the encryption algorithm utilized on the encrypted portion of the transport stream, provide data needed for an authorized decryptor to deduce a decryption key, and identify those portions of the transport stream that pass unencrypted or encrypted. A TAG packet may include further data identifying which portions of the encrypted stream are used for respective processes (demultiplexing or indexing for trick modes or thumbnail extraction). Further still, a TAG packet is inserted in compliance with the multiplexed transport stream.

A TAG packet may be generated in correspondence with all encrypted portions of a transport stream. Alternatively, encryption method packets may be generated in correspondence with individual packets or bytes of encrypted PES payload data. Thus, a TAG packet may be generated in correspondence with each PES header in a transport stream, in correspondence with a predetermined number of PES headers in a transport stream, or in correspondence with a predetermined pattern of packets that pass unencrypted for other processes.

FIG. 5 shows an exemplary flow of operations for a transmitter to protect ES content within a transport stream (as compared to when ES content is not carried by transport stream), according to one embodiment. The following list describes aspects of FIG. 5.
scr—This variable is set to “yes” if the current TS packet is to be commonly scrambled, or to “no” otherwise.
key_sync—This variable is set to “yes” if the transmitter is renewing the AES key, or to “no” otherwise.
PID (13 bit)—The PID value of the selected elementary stream.
base_counter—This 64 bit field is uniquely defined by the transmitter throughout the lifetime of the transmitter. In one implementation, bits zero through 50 represent the section_counter, and bits 51 through 63 are reserved for the PID.
Section_counter (51 bit)—A cyclic counter that is incremented for each no-to-yes transition of the scr state variable.
minor_counter—A 64 bit counter that is incremented for each block of 16 scrambled bytes.
i—A 4 bit counter that is incremented for each scrambled byte.
scramble 16—AESKEY [base_counter|minor_counter].

After the Replace AES Key event occurs, a transmitter immediately stops scrambling all PIDs until it resynchronizes with each PES component. This transition guarantees that all PIDs from the same program are scrambled with the same key. When defining the scr status, the transmitter sets, for each received TS packet, the scr state variable to “no” if any of the following conditions apply:
key_sync=yes
The TS packet includes whole or part of a PES header
The TS packet includes whole or part of one or more of the Stream Marks listed in the following table. A Stream Mark is composed of an MPEG Start code and its following data payload, as shown above in TABLE 1.

FIG. 6 shows an exemplary transport stream, according to one embodiment. A transmitter inserts a TAG packet in front of any TS packet left in the clear. As shown in FIG. 6, the following two possible scenarios may occur. Case A: A TAG packet is inserted in front of a packet containing all or part of a PES header. Case B: A TAG packet is inserted in front of a packet containing all or part of a Stream Mark.

Further, embodiments do not require that a TAG packet be inserted into the transport stream. Since a TAG packet is not needed until a point of decryption, a TAG packet may be transmitted to a processor in-band or out-of-band (e.g., by a private table), as long as it is received by the processor by the point of decryption. In addition, a TAG packet may be transmitted to a content usage license that is then transmitted in-band or out-of-band to a processor.

### Mapping Protected ES for into a MAU Payload Format

Protected ES is mapped to the MPF such that sections of a MAU in a commonly scrambled transport stream are left in the clear. This mapping allows for a media consumer to process each MAU independently. In one implementation, a transmitter such as content source 202 implements these mapping operations.

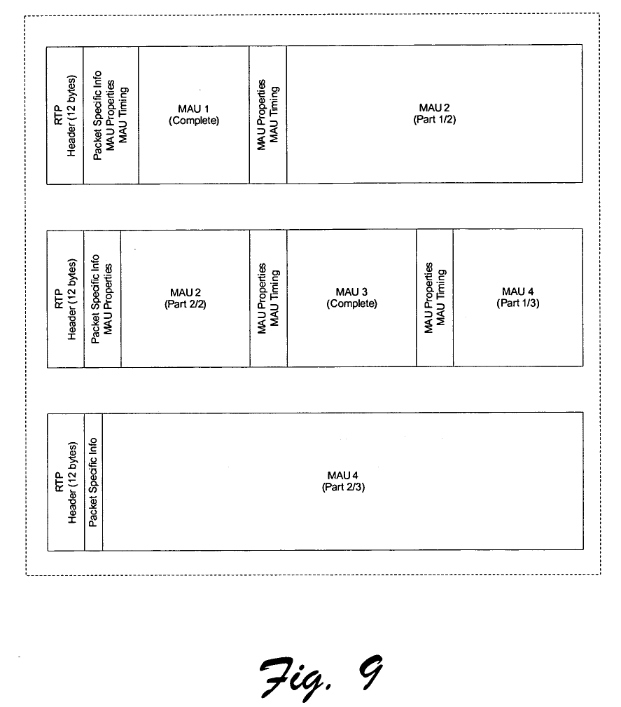

Syntax of a conventional RTP header is defined in RFC-3550 and shown in FIG. 11. Along with the RTP header, systems 100 of FIG. 1 and system 200 of FIG. 2 map protected ES content (e.g., protected ES content 120 of FIG. 1) to a MAU Payload Format (MPF). However, all media streams in a multi-media presentation need not use a same MPF, and different payload formats may be used. We now describe how MAUs are encapsulated in MPF.

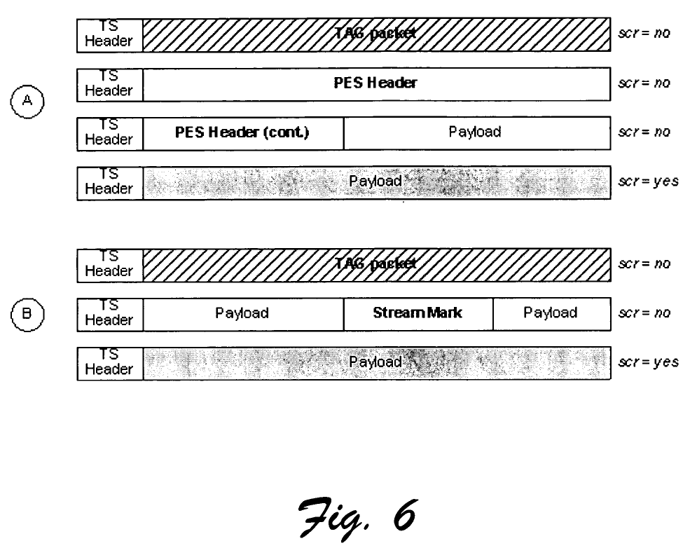

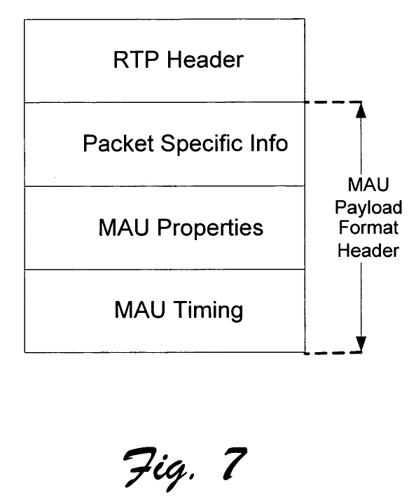

FIG. 7 illustrates exemplary high-level structure of the MPF Header, according to one embodiment. The header is shown in relation to a standard RTP header. The MPF Header is inserted by a transmitter (e.g., computer 102 of FIG. 1 and/or media center 204 of FIG. 2) in front of each MAU, or fragment thereof, in the transport packet. As shown in FIG. 7, the MPF Header in this exemplary implementation is divided into three sections. Each section starts with a one-byte bit field, and is followed by one or more optional fields. In some cases, up to two entire sections may be omitted from the MPF Header. Thus, an MPF Header may be as small as one byte.

The MPF Header is followed by a “payload”. The payload includes a complete MAU, or a fragment thereof. The payload may contain a partial MAU, allowing large MAUs to be fragmented across multiple payloads in multiple transport packets. The first payload may be followed by additional pairs of MPF Headers and payloads, as permitted by the size of the transport packet.

The first section of the MPF Header, which is called “Packet Specific Info” in FIG. 7, contains information which is specific to all payloads in the transport packet. The “Packet Specific Info” section is only included once in each transport packet, in the first MPF Header, which appears directly following the end of the RTP header. The second section, called “MAU Properties”, contains information that describes the payload. For example, this section specifies if the payload contains a MAU which is a sync-point, such as a video I-frame, and it also specifies how the size of the payload is determined. Additionally, this section contains information to allow a receiver to parse the transport packet if the previous packet was lost. This is useful if a MAU is fragmented across multiple transport packets.

The third section, called “MAU Timing”, provides information about various timestamps associated with the MAU in the payload. For example, this section specifies how the presentation time of the MAU is determined. This section also includes extension mechanisms allowing additional information to be included in the MPF Header.

FIG. 8 shows an exemplary detailed layout of an MPF header of FIG. 7, according to one embodiment. Each of the three sections 802 through 806 of FIG. 8 includes several individual header fields. These fields are shown as boxes in FIG. 8. The heights of the boxes give an indication of the relative sizes of the header fields. However, the figure is not entirely drawn to scale, and it should be noted that the “Extension” field has a variable size.

Referring to FIG. 8, the first header field in each of the three sections is a bit field. The other header fields in a section are only present if indicated by that section's bit field. In some cases an entire section, including its bit field, may be omitted. Packet Specification Information (Info) section includes “Bit Field 1”, and may also include any of the other fields shown in FIG. 8. Additional MPF Headers in the same transport packet begin with “Bit Field 2” and include the fields in the “MAU Properties” section and the “MAU Timing” section.

In the simplest possible case, a transport packet contains a single, complete, MAU. In this case, it is possible to include all of the header fields. However, fields which are not needed may be omitted. Each of the three sections of the MPF Header has a bit field which indicates which, if any, of the fields in the section are present.

For example, the “Offset” field, which specifies the byte offset to the end of the current payload, is not needed when the packet contains a single payload, because the length of the payload can be inferred by the size of the transport packet. The “OP” bit in “Bit Field 2” indicates if the “Offset” field is present. If all of the bits in “Bit Field 3” are zero, then the “Bit Field 3” itself can be omitted, and this is indicated by setting the “B3P” bit in “Bit Field 2” to zero.

It is possible to combine multiple payloads in a single transport packet. This is referred to as “grouping”. The “Offset” field indicates the use of “grouping”. If the “Offset” field is present, another MPF Header and another payload may follow after the end of the current payload. The “Offset” field specifies the number of bytes to the end of the current payload, counted from the end of the “Offset” field itself. To determine if another MPF Header follows the end of the current payload, implementations need to consider not only the value of the “Offset” field but also the size of the transport packet, and the size of the RTP padding area, if any in the case RTP is used as the transport protocol.

A single MAU can be split into multiple payloads. This is referred to as “fragmentation”. The primary use for fragmentation is when a MAU is larger than what can fit within a single transport packet. The “F” field in “Bit Field 2” indicates if a payload contains a complete MAU or a fragment thereof.

The fields in the “MAU Timing” section should only be specified in the MPF Header for the payload which contains the first fragment of a MAU. The only exception to this is if the “Extension” field in the “MAU Timing” section contains an extension which is different for different fragments of the same MAU. When a MAU is fragmented, the bits “S”, “D1” and “D2” in “Bit Field 2” are only significant in the MPF Header for the payload which contains the first fragment. Therefore, receivers (media consumers) ignore these bits if the value of the “F” field is 0 or 2.

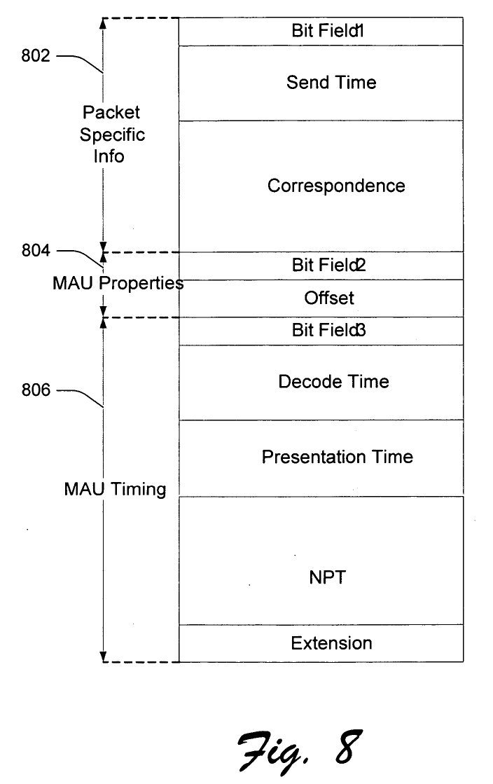

In this implementation, a MAU is not fragmented unless the MAU is too large to fit in a single transport packet. In this implementation, a fragment of one MAU is not combined with another MAU, or a fragment of another MAU, in a single transport packet. However, receivers may still handle these cases. An example of this is shown in FIG. 9.

FIG. 9 illustrates an exemplary sequence of three Real-Time Transport Packet packets that use the MPF, according to one embodiment. The three transport packets carry the data of 4 MAUs. The fourth MAU is continued in a fourth transport packet (not shown.) The figure shows how fragmentation of MAUs can be used to create fixed size transport packets, if so desired. As can be seen in the figure, MAU 2 is fragmented across two transport packets. In the first transport packet, the MPF Header for MAU 2 specifies that MAU 2 is continued in the next transport packet. (This is signaled using the “F” field in Bit Field 2).

The second transport packet starts with an MPF Header which omits the “MAU Timing” field, because the “MAU Timing” field for MAU 2 had already been specified in the first transport packet. The “Offset” field in the “MAU Properties” section is used to find the start of the Payload Format Header for MAU 3. This allows the client to decode MAU 3 even if the previous transport packet was lost. Similarly, the figure shows how MAU 4 is fragmented across the second and third transport packets. However, MAU 4 is so big that no additional MAUs can be inserted in the third transport packet. In this example, MAU 4 is continued in a fourth transport packet, which is not shown. In situations like this, the third transport packet's Payload Format Header does not need to include the “Offset” field, and it may be possible to omit the entire “MAU Properties” section. The remaining part of the MPF Header then only includes of the “Packet Specific Info section”, and it can be as small as a single byte.

If a MAU is fragmented into multiple payloads, the payloads are usually carried in separate transport packets. However, this MPF also allows multiple payloads for the same MAU to be carried within a single transport packet.

If a payload in the transport packet contains a fragment of a MAU, this is indicated by the “F” field in “Bit Field 2”.

FIG. 10 shows an example where a single MAU has been split into three fragments in a same RTP packet, according to one embodiment. In this example, the “F” field in the first MPF Header is set to 1, to indicate that the first payload contains the first fragment of the MAU. The “MAU Timing” section is present only in this first payload. The “F” field in the second MPF Header is set to 0, to indicate that its payload contains a fragment, which is neither the first nor the last fragment of the MAU. The “F” field in the third MPF Header is set to 2, to indicate that its payload contains the last fragment of the MAU.

In addition to the usual RTP sampling clock and wallclock, the MPF provides several additional timestamps and notions of time, which are now described. The RTP header has a single timestamp, which specifies the time at which the data in the packet was sampled. This timestamp is sometimes called the sampling clock. It is useful to note that the RTP timestamps of packets belonging to different media streams cannot be compared. The reason is that the sampling clock may run at different frequencies for different media streams. For example, the sampling clock of an audio stream may run at 44100 Hz, while the sampling clock of a video stream may run at 90000 Hz. Furthermore, RFC-3550 specifies that the value for the initial RTP timestamp should be chosen randomly. In effect, each media stream has its own timeline. In this document, each such timeline is referred to as a “media timeline”.

RTP allows the timelines for the different media streams to be synchronized to the timeline of a reference clock, called the “wallclock”. RTP senders allow the receiver to perform this synchronization by transmitting a mapping between the sampling clock and the wallclock in the RTCP Sender Report packet. A different RTCP Sender Report has to be sent for each media stream, because the media streams may use different sampling clocks.

The mappings are updated and transmitted again at some interval to allow the receiver to correct for possible drift between the wallclock and the sampling clocks. Clock drift may still be a problem if the sender's wallclock drifts in relation to the receiver's wallclock. The two clocks could be synchronized using the NTP protocol, for example, but the RTP specification does not specify a particular synchronization method. Please note that the wallclock originates from the encoder. If the RTP sender and the encoder are separate entities, the wallclock is typically unrelated to any physical clock at the sender.

This MPF uses a third timeline, called the Normal Play Time (NPT) timeline. The NPT timeline is useful primarily when RTP is used to transmit a media “presentation”. Timestamps from the NPT timeline commonly start at 0 at the beginning of the presentation. NPT timestamps are particularly useful when transmitting a pre-recorded presentation, because the timestamps can assist the receiver with specifying a position to seek within the presentation. This assumes the existence of some mechanism for the receiver to communicate the new position to the RTP sender.

Since RTP was designed for multi-media conferencing applications, the RTP specification does not discuss the NPT timeline. However, other protocols which are built on top of RTP, such as RTSP (a control protocol for video on-demand applications) include the concept of the NPT timeline. In RTSP, the control protocol provides a mapping between the NPT timeline and the media timeline for each media stream.

The MPF defines a mechanism for specifying the NPT timeline timestamp associated with a MAU. However, when practical, an out-of-band mapping between the media timeline and the NPT timeline, such as the one defined by RTSP, may be preferable, since it reduces the overhead of the MPF Header.

All RTP-compliant systems handle the wrap around of timestamps. At the typical clock frequency of 90000 Hz, the RTP timestamp will wrap around approximately every 13 hours. But since the RTP specification says that a random offset should be added to the sampling clock, a receiver may experience the first wrap around in significantly less than 13 hours. The wrapping around of the RTP timestamp is usually handled by using modular arithmetic. When modular arithmetic is used, timestamps are usually compared by subtracting one timestamp from another and observing if the result is positive or negative.

In the MPF, each MAU has a “Decode Time” and a “Presentation Time.” The decode time is the time by which the MAU should be delivered to the receiver's decoder, and the presentation time is the time at which the MAU should be presented (displayed or played) by the receiver. Both times belong to the media timeline. Since the delays in the network and in the decoder are not typically known to the RTP sender, the receiver does not use the absolute values of a decode timestamp or a presentation timestamp. The receiver considers only the relative difference between a pair of decode timestamps or a pair of presentation timestamps.

In some cases, such as when a video codec produces bi-directional video frames, MAUs may be decoded in a different order from which they will be presented. In this implementation, the RTP sender transmits the MAUs in the order they should be decoded.

The “Timestamp” field in the RTP header maps to the presentation time of the first MAU in the transport packet. Since the transport packets are transmitted in decode order, the presentation time timestamps of consecutive MAUs may not be monotonically non-decreasing.

The MPF Header includes an optional “Decode Time” field, which is used to specify the decode time of the MAU in the payload. The MPF Header also includes a “Presentation Time” field which is used to specify the presentation time of the MAU, when the transport packet contains more than one MAU. When only a single MAU is included in the transport packet, the “Presentation Time” field because the “Timestamp” field serves as a replacement for that field in the first MAU in the packet. In this implementation, both the “Decode Time” and the “Presentation Time” fields are expressed using the same clock resolution as the “Timestamp” field.

The term “trick play” refers to the receiver rendering the media presentation at a non-real time rate. Examples of trick play include fast forwarding and rewinding of the presentation. If the RTP sender is transmitting in trick play mode, the decode timestamp and presentation timestamp for each MAU should increment at the real-time rate. This allows the decoder to decode the MAUs without knowing that trick play is used. The “Decode Time” and “Presentation Time” fields in the MPF Header are unaffected by trick play, the “NPT” field, if present, is not. For example, if a media presentation is being rewound, the “Presentation Time” timestamp fields of MAUs will be increasing, while the value of the “NPT” field will be decreasing.

The “NPT” field in the MPF Header specifies the position in the Normal Play Time timeline where the MAU belongs. If the “NPT” field is not present, a receiver can calculate the normal playtime of the MAU from the presentation time, provided that a mapping between the two timelines is available. Various approaches for establishing this mapping are discussed below. Since the RTP sender adds a random offset to the timestamps in the media timeline, the presentation time timestamp is not used as a direct replacement for the NPT timestamp. Even if this random offset is known to the receiver, the wrap around of the media timeline timestamps can be a problem.

A possible solution to these problems is for the sender to use an out-of-band mechanism to provide a mapping between the Normal Play Time timeline and the media timeline. This mapping could be provided only once at the beginning of the transmission or repeatedly as needed. Additionally, if trick play is possible, the sender communicates the trick play rate. For example, if the presentation is being rewound, the trick play rate is negative. The receiver uses the trick play rate to generate NPT timestamps that decrease as the presentation time increases.

If the mapping is provided only once at the beginning of the transmission, the receiver establishes a mapping between the Normal Play Time timeline and the wallclock timeline. This is usually possible as soon as an appropriate RTCP Sender Report packet is received. It is preferable to calculate the NPT timestamp for each MAU based on the MAU's wallclock time because timestamps from the media timeline may drift against the wallclock timeline.

The RTSP protocol is an example of a control protocol which provides a mapping between the Normal Play Time timeline and the media timeline at the beginning of the transmission. Another solution, which may provide a suitable trade-off between complexity and overhead, is to include the “NPT” field only on sync-point MAUs. The “NPT” field is used to establish a mapping between the normal play time timeline and the presentation or wallclock timelines. For non-sync point MAUs, the receiver calculates the NPT timestamp using the previously established mapping. When trick play is used, the sender would include the “NPT” field for every MAU.

The “Send Time” field in the MPF Header specifies the transmission time of the transport packet. This can be useful when a sequence of transport packets is transferred from one server to second server. Only the first server needs to compute a transmission schedule for the packets. The second server will forward the transport packets to other clients based on the value of the “Send Time” field. It is not required to include the “Send Time” field when forwarding transport packets to a client. However, clients can use the “Send Time” field to detect network congestion by comparing the difference between the values of the “Send Time” fields in a series of packets against the difference in packet arrival times. The “Send Time” field uses the same units as the media timeline.

The “Correspondence” field provides a mapping between the wallclock timeline and the current media timeline. When RTP is the transfer protocol, then this is the same mapping provided in RTCP Sender Reports. Including the mapping in the transport packet is more efficient than transmitting a separate RTCP packet. This allows the sender to reduce the frequency of RTCP Sender Reports and still transmit the mapping as frequently as desired.

FIG. 11 illustrates a standard 12-byte RTP header for reference purposes. Referring to FIG. 11:
“Version” (V) field: 2 bits. This field is set to 2.
“Padding” (P) bit: This bit is used to add padding to the end of the RTP packet.
“Extension” (X) bit: This bit is set to 1 if an RTP header extension is present. The RTP profile defines how the header extension is used. A receiver is able to parse or skip over the header extension should the RTP header have a non-zero “Extension” bit.
“Contributing Source” (CC) field: 4 bits. A receiver is able to correctly parse, or skip over, the list of contributing sources should the RTP header have a non-zero contributing source field.
“Marker” (M) bit: This bit is set to 1 if any of the payloads in the transport packet contain a complete MAU or the last fragment of a MAU.
“Payload Type” (PT) field: 7 bits. The assignment of an RTP payload type is outside the scope of this document. It is specified by the RTP profile under which this Payload Format is used or signaled dynamically out-of-band (e.g., using SDP.)
“Sequence Number” field: 16 bits. This field contains a number that increments by 1 for each transport packet sent with the same SSRC value. The initial value of the RTP sequence number may be communicated to the client through non-RTP means.
“Timestamp” field: 32 bits. This field specifies a time stamp that applies to the first payload that is included in the transport packet. By default, the field is interpreted as a presentation time. The clock frequency of the “Timestamp” field is recommended to be 90 kHz, i.e., the resolution is 1/90000 seconds. The sender and receiver may negotiate a different clock frequency through non-RTP means.
“Synchronization Source” (SSRC) field: 32 bits transport packets with the same value for the SSRC field share the same timeline for the “Timestamp” field and the same number space for the “Sequence Number” field.

The RTP header is followed by a MPF Header. The only exception is a transport packet that only includes padding. In that case, the MPF Header is not present. If a transport packet contains data from multiple MAUs, the MPF Header appears in front of each MAU and in front of each fragmented (partial) MAU. Thus, transport packets using this Payload Format may contain one or more MPF Headers. The layout of the MPF Header is shown in FIG. 7. When the MPF Header directly follows the standard 12-byte RTP header, it begins with the 1-byte field called “Bit Field 1”, followed by a series of optional fields. The header is followed by a payload. The payload includes of either a complete MAU or a fragment (partial) MAU.

After the first data payload, another MPF Header may appear, followed by another data payload. The process of adding another MPF Header after a data payload may be repeated multiple times. Each MPF Header which follows the first data payload with the “Bit Field 2” field.

The following describes the layout of the field “Bit Field 1”.
“Send Time Present” (ST) bit: If this bit is 1, a 32 bit “Send Time” field is inserted directly following the end of the “Bit Field 1” field.
“Correspondence Present” (CP) bit: If this bit is 1, a 96 bit “Correspondence” field is inserted after the “Send Time” field.
R1, R2, R3 (1 bit each): For each of these bits that is set to 1, the receiver assumes that a 32 bit field has been added between the “Correspondence” field and “Bit Field 2”. The meaning of these 32 bit fields is not defined in this specification. A receiver which does not know the meaning of the 32 bit fields ignores them.
R4, R5 (1 bit each): Reserved for future use; currently set to 0.
“Bit Field 2 Present” (B2P) bit: If this bit is 1, the 1 byte “Bit Field 2” field is inserted after the “Correspondence” field.
“Send Time” field: 32 bits. This field specifies the transmission time of the transport packet, using the same time units that are used for the “Timestamp” field in the RTP header.
“Correspondence” field: 96 bits. The field includes two timestamps. A 64 bit wallclock timestamp in NTP format and a 32 bit decode time timestamp. The two fields are used in the same way as the “NTP timestamp” and the “RTP timestamp” field in the RTCP Sender Report, which is defined in section 6.4.1 of RFC-3550.

When “Bit Field 1” is present, “Bit Field 2” is optional. The “B2P” bit in “Bit Field 1” determines if “Bit Field 2” is present. The default value for all bits in “Bit Field 2” is 0. “Fragmentation” field (F) indicates if the data payload includes of a partial MAU. One or more such payloads is combined to reconstruct a complete MAU. The “F” field also indicates if the payload contains the first or last fragment of the MAU. The “S”, “D1” and “D2” bits (below) are only valid when the value of the “F” field is 0 or 3. TABLE 2 shows exemplary meanings of the F field value.

TABLE 2

| F | |
|---|---|
| field value | Meaning |
| 0 | Payload contains fragment of MAU other than the first or last |
| | fragment. |
| 1 | Payload contains first fragment of MAU. |
| 2 | Payload contains last fragment of MAU. |
| 3 | Payload contains complete MAU (not fragmented.) |

“Offset Present” bit (OP): If this bit is 1, the 16 bit “Offset” field is inserted directly after “Bit Field 2”. The “Offset” field is used to find the end of the current payload. Another MPF Header, starting with “Bit Field 2” may follow the end of the current payload. If the “Offset Present” bit is 0, the “Offset” field is absent; when MPF is used with RTP, the current payload extends to the end of the transport packet or to the start of the RTP padding area if the “Padding” bit in the RTP header is 1.

“Sync Point” bit (S): This bit is set to 1 when the MAU is a sync-point MAU. “Discontinuity” bit (D1): This bit is set to 1 to indicate that one or more MAUs are missing, even though the sequence number of the transport packets (e.g., RTP sequence number, if RTP is used) does not indicate a “gap”. “Droppable” bit (D2): If this bit is 1, and it is necessary to drop some MAUs, this MAU can be dropped with less negative impact than MAUs that have the D2 bit set to 0. “Encryption” bit (E): This bit is set to 1 to indicate that the payload contains encrypted data. The bit should be set to 0 if the payload does not contain encrypted data. “Bit Field 3 Present” (B3P) bit: If this bit is 1, the 1 byte “Bit Field 3” field is inserted after the “Length” field. “Offset”: A 16 bit field which specifies the offset, in bytes, to the end of the current payload, counted from the first byte following the “Offset” field. In other words, the value of the “Offset” field is the size of the “MAU Timing” section, if any, plus the size of the current payload.

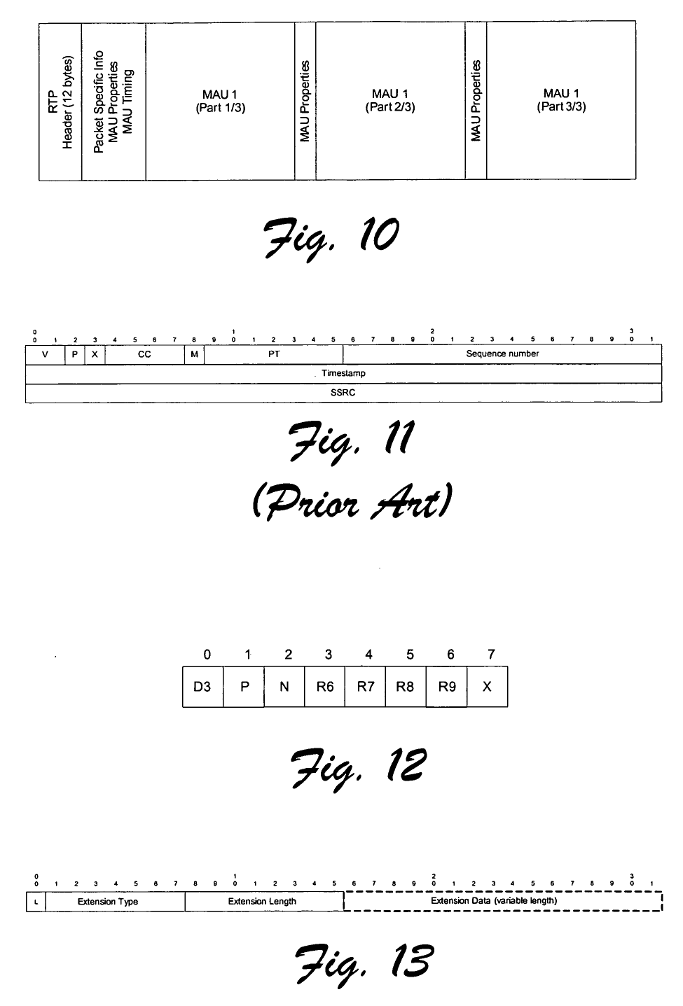

The value of the “B3P” bit in “Bit Field 2” determines if “Bit Field 3” is present. The default value for all bits in “Bit Field 3” is 0. FIG. 12 shows an exemplary layout of Bit Field 3 of the MPF. “Decode Time Present” bit (D3): If this bit is 1, the 32 bit “Decode Time” field is inserted after “Bit Field 3” but before the “Presentation Time” field. “Presentation Time Present” bit (P): If this bit is 1, the 32 bit “Presentation Time” field is inserted after the “Decode Time” field but before the “NPT” field. “NPT Present” bit (N): If this bit is 1, the 64 bit “NPT” field is inserted immediately after the “Presentation Time” field. R6, R7, R8, R9: For each of these bits that is set to 1, the receiver assumes that a 32 bit field has been added between the “NPT” field and the “Extension” field. The meaning of these 32 bit fields is not defined in this specification. A receiver which does not know the meaning of the 32 bit fields ignores them.

“Extension Present” bit (X): If this bit is 1, a variable size “Extension” field is inserted after the “NPT” field. “Decode Time”: A 32 bit field. This field specifies the decode time of the MAU. When RTP is used, this field specifies the decode time of the MAU using the same time units that are used for the “Timestamp” field in the RTP header. “Presentation Time”: A 32 bit field. This field specifies the presentation time of the MAU. “NPT” field: A 64 bit timestamp. The NPT field specifies the position in the Normal Play Time timeline to which the MAU belongs.

FIG. 13 shows an exemplary layout of the extension field of an MPF Header, according to one embodiment. The “Extension” field includes of one or more collections of fields. FIG. 13 illustrates the layout of the fields contained in one such collection. “L” bit: If this bit is 1, this is the last collection of “Extension” fields. If the bit is 0, the end of the “Extension Data” field is followed by at least one more collection of “Extension” fields.

“Extension Type”: A 7 bit field which is used to identify the contents of the “Extension Data” field. In addition, the values 0 and 127 are reserved for future use. “Extension Length”: An 8 bit number giving the size, in bytes of the “Extension Data” field that appears directly following this field.“Extension Data”: Variable length field. The size of this field is given by the “Extension Length” field.

The fields in the “Extension” field have the following values when the Initialization Vector extension is used.
“Extension Type”: Is 2.
“Extension Length”: The size of the “Extension Data” field, in bytes.
“Extension Data”: A sequence of one or more bytes, to be used as part of the initialization vector for the current MAU. When this extension is present, the encryption unit is a complete MAU. If the MAU is fragmented into multiple payloads, the Initialization Vector extension is present only in the first payload.

The fields in the “Extension” field have the following values when the Key ID extension is used.
“Extension Type”: Is 3.
“Extension Length”: The size of the “Extension Data” field, in bytes.
“Extension Data”: A sequence of one or more bytes, which identify the decryption key to use for decrypting the current payload.

The Key ID extension remains effective until replaced by a different Key ID extension. Therefore, the extension is only used when a payload requires the use of a decryption key that is different from the decryption key of the previous payload. However, if the previous payload was contained in a transport packet which was lost, the receiver may be unaware of that a change of decryption key is necessary. If a payload is decrypted with the wrong key, and this situation is not detected, it can lead to undesirable rendering artifacts.

One approach to reduce severity of this problem is to specify the Key ID extension for the first payload of every MAU which is a sync-point. This is a good solution if it is known that a lost MAU will force the receiver to discard all MAUs until it receives the next sync-point MAU. A more conservative solution is to specify the Key ID extension for the first payload in each multiple-payload transport packet. This solution is robust against packet loss, since the interdependent payloads are all contained within a single transport packet.

When MPEG video headers are present, they precede the subsequent frame. Specifically:
An MPEG Video Sequence_Header, when present, is at the beginning of the MAU.
An MPEG GOP_header, when present, is at the beginning of the MAU, or follows a Video_Sequence_Header.
An MPEG Picture_Header, when present, is at the beginning of a MAU, or follows a GOP_header.

Unlike RFC 2250, if a MAU containing video is fragmented, there is no requirement to perform fragmentation at a slice boundary.

MAUs may be fragmented across multiple transport packets for different reasons. For example, a MAU may be fragmented when transport packet size restrictions exist and when there are differences in encryption parameters for specific portions of the MAU. When RTP Header Fields are interpreted, the “Timestamp” field in the RTP header is set to the PTS of the sample with an accuracy of 90 kHz, and the “Payload Type” (PT) field is set according to out-of-band negotiation mechanisms (for example, using SDP). With respect to the MPF, the packet specification information section, the presence of the “Send Time” field is optional, the presence of the “Correspondence” field is optional, and the “Bit Field 2Present” bit (B2P) is set in case the payload contains a portion of a MAU which is encrypted, or a fragment of a MAU which is encrypted.

In view of the above, the MPF allows for a single MAU to be encrypted according to different encryption parameters. That includes the ability to have fragments of a single MAU which are encrypted while others may be left in the clear. In such cases, a MAU may be fragmented into multiple payloads, each with different encryption parameters. For example, a MAU or a fragment of a MAU which is encrypted has values and fields set according to the following criteria:
The “Bit Field 2 Present” bit (B2P) in the Packet Info section is set to 1, to indicate that a “Bit Field 2” is present.
The “Encryption” bit (E) in the MAU Properties section is set to 1, to indicate that the payload is encrypted.
The “Extension Present” bit (X) in the “MAU Timing” section is set to 1, to indicate the presence of Extension fields.
An “Initialization Vector” extension is included. The following values are set:
   The “Extension Type” is set to 2.
The “Extension Length” is set to 8 (meaning 64 bits) if the “Extension Data” field contains only a data segment ID, or 16 (meaning 128 bits) if the “Extension Data” field contains both a data segment ID and a block ID.
   The “Extension Data” is set with the data segment ID value as described above in case the initial block ID is zero. If the initial block ID is different from zero, then the “Extension Data” is set to the data segment ID followed by the initial block ID.
   This extension is included for each encrypted payload of a MAU.
A “Key ID” extension is included. The following values are set:
   The “Extension Type” is set to 3.
   The “Extension Length” is set to 16 (meaning 128 bits).
   The “Extension Data” is set with the Key ID value from the license which corresponds to this MAU.
The “Initialization Vector” and “Key ID” extensions are included for the first payload of a new MAU in each multiple-payload transport packet that contains multiple MAUs. This ensures that a receiver knows about the current Key ID even if some transport packets are lost.

The MAU Properties section is interpreted as follows:
The “Sync Point” bit (S) is set when the MAU contains a video I-Frame or an audio frame.
The “Discontinuity” bit (D1) is set when one or more MAUs are missing. For example, when video frames were dropped by a frame dropping translator.
The utilization of the “Droppable” bit (D2) is optional. Defining in which cases it should be used is outside of the scope of this specification.
The “Encryption” bit (E) is set in case the payload contains a portion of a MAU which is encrypted, or a fragment of a MAU which is encrypted.

The MAU Timing section is interpreted as follows:
The “Decode Time” field is optional. If used, it contains the DTS of the MAU.
The “Presentation Time” field is optional.
The “NPT” field is optional.
   The “Extension Present” bit (X) is set when one or more extension headers are present.
      Exemplary Procedure

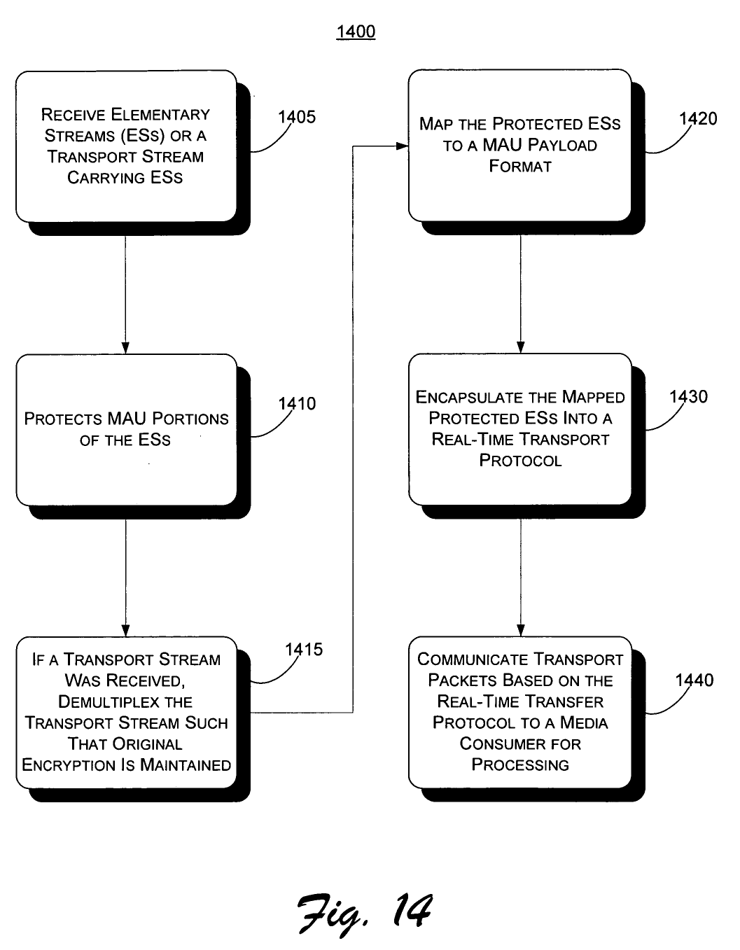

FIG. 14 shows an exemplary procedure 1400 to protect ES content, according to one embodiment. For purposes of exemplary illustration, operations of procedure 1400 are performed by one or more of ES protection module 112 of FIG. 1, mapping module 114, transport stream scrambling module 210 of FIG. 2, and/or demultiplexing and packaging module 212. Various changes and modifications will become apparent to those skilled in the art from the present description, including changes and modifications to the order of actions.

Referring to FIG. 14, at block 1405, elementary streams (ESs) are received or otherwise accessed by computing device 102 or content source 202. The accessed ESs may be independent of a transport stream, or carried by a transport stream. At block 1410, procedure 1400 protects MAU portions of the ESs. In one implementation, these protection operations are performed independent of common scrambling. In another implementation, these protection operations are performed using common scrambling, for example, when common scrambling a transport stream. At block 1415, if a transport stream was accessed at block 1405, the transport stream is demultiplexed into ESs such that original encryption is maintained. Demultiplexing operations of module 212 illustrates an exemplary component to perform transport stream demultiplexing operations.

At block 1420, the procedure 1400 maps protected ESs to the MAU Payload Format (MPF). Mapping each MAU to the MPF provides a media consumer that receives transport packets encapsulating the mapped ESs with enough information to allow the media consumer to process each ES independently of any other ES, and process each MAU independently of any other MAU. At block 1430, the procedure 1400 encapsulates the ESs mapped to the MPF into a transport protocol. In one implementation, the transport protocol is the Real-Time Transport Protocol (RTP). At block 1440, the procedure 1400 communicates transport packets based on the transport protocol to a media consumer for processing. Such processing, which includes decryption, allows the media consumer to experience the payload data contained in the transport packets.

Conclusion

Although protecting ES content has been described in language specific to structural features and/or methodological operations or actions, it is understood that the implementations defined in the appended claims are not limited to the specific features or actions described. Rather, the specific features and operations are disclosed as exemplary forms of implementing the claimed subject matter.

1. A computer-implemented method comprising:
identifying data segments of elementary stream content, each data segment comprising a single video or audio frame;
selecting encryption boundaries for protection of the elementary stream content, the encryption boundaries corresponding to the data segments; and
protecting the elementary stream content using the encryption boundaries.

2. The method of claim 1, wherein the elementary stream content is carried by a transport stream

3. The method of claim 1, wherein protecting further comprises encrypting respective ones of the data segments with Advanced Encryption Standard in Counter Mode.

4. The method of claim 1 wherein protecting further comprises:
analyzing a transport stream to determine portions of the transport stream that are to pass unencrypted; and
wherein protecting further comprises preparing the transport stream for processing that bypasses commonly scrambled portions of the transport stream.

5. The method of claim 1, wherein an elementary stream of the elementary stream content comprises Media Access Units (MAUs), and wherein protecting further comprises:
for each MAU of the MAUs, applying a respective set of encryption parameters to each data segment of one or more data segments associated with the MAU, the respective encryption parameters either encrypting the data segment or leaving the data segment in the clear such that respective sets of encryption parameters apply to each separate data segment.

6. The method of claim 5, wherein each data segment is a contiguous section of the MAU.

7. The method of claim 5, wherein a portion of the MAU is left in the clear.

8. The method of claim 5, wherein the transport protocol is the Real-Time Transport Protocol (RTP).

9. The method of claim 5, further comprising mapping the MAUs to a MAU Payload Format for encapsulation into a transport protocol.

10. The method of claim 9, wherein the MAU Payload Format comprises packet specific information associated with each of the MAUs.

11. The method of claim 9, wherein the MAU Payload Format comprises a MAU properties section for describing a particular MAU of the MAUs; and
if the MAU is fragmented, the properties section including information to allow a receiver to parse the MAU when a fragmented portion of the MAU is lost.

12. The method of claim 9, wherein the MAU Payload Format comprises a MAU timing section to provide information about timestamps associated with a MAU of the MAUs.

13. The method of claim 12, wherein the information comprises a Normal Play Time (NPT) timeline associated with the MAU, the NPT for assisting specification, by a receiver, a position to seek to within a presentation.

14. The method of claim 12, wherein the information comprises a presentation time indicating when the receiver is to present content of the MAU.

15. A computer-implemented method comprising:
receiving encrypted portions of an elementary stream (ES), the ES being represented with multiple Media Access Units (MAUs), each MAU corresponding to a single frame of video or audio of the ES, the ES being associated with information allowing the ES to be processed independent of any other ES, and each MAU being associated with information allowing the MAU to be processed independent of any other MAU; and
processing the ES or at least one MAU of the MAUs.

16. The method of claim 15, wherein the elementary stream is carried by a commonly scrambled transport stream.

17. The method of claim 15, wherein the ES is encapsulated by Real-Time Transport Protocol (RTP) packets.

18. The method of claim 15, wherein the elementary stream is carried by a transport stream, and wherein processing further comprises demultiplexing the transport stream to derive elementary streams.

19. A computer-implemented method comprising:
identifying Media Access Units (MAUs) of elementary stream content;
for each MAU of the MAUs, the MAU comprising one or more data segments representing a single video or audio frame, selecting encryption boundaries based on the one or more data segments for protection of the single video or audio frame and associated headers; and
protecting the elementary stream content based on the encryption boundaries such that each data segment is associated with a respective set of encryption parameters that is independent of another data segment's corresponding encryption parameters.

20. The method of claim 19, wherein the elementary stream content is carried by a transport stream, and wherein protecting further comprises commonly scrambling the transport stream to prepare the transport stream for processing that bypasses encrypted content.
